(19) United States
(12) Patent Application Publication
(10) Pub. No.: US 2026/0202359 A1
(43) Pub. Date: Jul. 16, 2026

(54) SAMPLE MOUNT ASSEMBLY FOR AN X-RAY IMAGING SYSTEM, X-RAY IMAGING SYSTEM, METHOD FOR OPERATING A SAMPLE MOUNT ASSEMBLY AND METHOD FOR OPERATING AN X-RAY IMAGING SYSTEM

(71) Applicant: Carl Zeiss SMT GmbH, Oberkochen (DE)

(72) Inventors: Johannes RUOFF, Cupertino, CA (US); Thomas Anthony Case, Walnut Creek, CA (US); Marc Schweitzer, Berkeley, CA (US); Scott Penner, Livermore, CA (US); Igor Fidelman, Danville, CA (US)

(21) Appl. No.: 19/015,888

(22) Filed: Jan. 10, 2025

(51) Int. Cl. G01N 23/046; G01N 23/044

(52) U.S. Cl. CPC G01N 23/046; G01N 23/044; G01N 2223/1016; G01N 2223/309; G01N 2223/321; G01N 2223/6116

(57) ABSTRACT

A sample mount assembly for an x-ray imaging system comprises: a main base; a rotation stage attached to the main base rotatably around a rotation axis; a linear slide attached relative to the rotation stage movably in a linear direction; and a support surface connected to, or formed integrally with, the linear slide for supporting the sample.

### FIELD

The present disclosure relates to a sample mount assembly for an x-ray imaging system, an x-ray imaging system with such a sample mount assembly, a method for operating such a sample mount assembly and a method for operating such an x-ray imaging system.

### BACKGROUND

X-rays are widely used in microscopy at least in part because of their short wavelengths and ability to penetrate objects. Three-dimensional (3D) x-ray imaging techniques can be useful to image internal structures of objects. Typically, based on a dataset including x-ray transmission images of a region of interest of a sample that are collected over a large angular range, 3D images of the region of interest are reconstructed. An x-ray imaging system usually comprises a rotatable sample mount to support a sample, an x-ray source configured to illuminate the region of interest of the sample, and a position-sensitive x-ray detector configured to record x-rays transmitted through the region of interest of the sample. In general, for precise x-ray imaging of a region of interest of a sample, the region of interest is accurately and stably placed on the sample mount and reliably rotated during the imaging process.

### SUMMARY

The present disclosure seeks to provide an improved sample mount assembly for an x-ray imaging system and an improved method for operating such a sample mount assembly.

According to an aspect, the disclosure provides a sample mount assembly for an x-ray imaging system is provided. The sample mount assembly comprises: a main base; a rotation stage attached to the main base rotatably around a rotation axis; a linear slide attached relative to the rotation stage movably in a linear direction, the linear direction being, for example, perpendicular to the rotation axis; a support surface connected to (e.g., fixedly connected to) the linear slide for supporting the sample, or formed integrally with the linear slide for supporting the sample. Optionally, the x-ray imaging system further comprises a lifting unit for lifting the sample from the support surface such that, in a lifted state, the rotation stage can be rotated without rotating the sample.

Having the sample mount assembly with the rotation stage, the linear slide and (optionally) the lifting unit, it can be possible to easily rearrange a sample on the support surface of the sample mount assembly such that a region of interest of the sample is positioned at the rotation axis of the rotation stage. With the region of interest of the sample being positioned at the rotation axis, the region of interest can be viewed under different rotation angles during x-ray imaging of the region of interest of the sample.

For example, the proposed sample mount assembly allows arranging any region of interest of the sample at the rotation axis of the sample mount assembly by setting only two degrees of freedom. The rotation stage can be rotated around the rotation axis in the lifted state of the lifting unit, i.e., without the sample. The linear slide can be moved in the linear direction in a lowered state of the lifting unit, i.e., together with the sample.

In contrast to certain conventional sample mount assemblies for x-ray imaging, the degrees of freedom to move a sample to a new region of interest can be reduced. For example, a conventional sample mount assembly typically provides at least three degrees of freedom. On the one hand, a rotary movement around a rotation axis for scanning the sample under different rotation angles during x-ray imaging. In addition, two more translational degrees of freedom for reposition of the sample such that a different region of interest can be placed at the location of the rotation axis.

In contrast, the proposed sample mount assembly uses only two degrees of freedom, namely a rotation around the rotation axis of the rotation stage and a linear movement of the linear slide in a direction perpendicular to the rotation axis. For example, the rotation around the rotation axis of the rotation stage is used for arranging a specific region of interest of the sample at the rotation axis. In addition, the rotation around the rotation axis of the rotation stage can be used for scanning the sample under different rotation angles during x-ray imaging. The rotation stage is not only used for the rotation during x-ray imaging but also for setting one of the positional coordinates of a specific region of interest of the sample. For example, the proposed sample mount assembly makes use of the fact that any position on a sample (e.g., any position in a main plane of extension of the sample) can be described (instead of by Cartesian coordinates) also by polar coordinates.

Using the rotation stage also for setting one of the positional coordinates of a specific region of interest of the sample can be possible by the lifting unit which decouples the rotation of the rotation stage from a rotation of the sample during setting an angular coordinate of the region of interest.

The proposed sample mount assembly can have a relatively simple configuration and relatively high stability. A sample can be maintained in a more stable and stationary state on the support surface when rotating the sample during x-ray imaging. The stability of the stage and, hence, of the sample during x-ray imaging is relevant to the spatial resolution of the x-ray imaging. With the proposed sample mount assembly a spatial resolution of the x-ray imaging system can be increased. For example, a wobble of the rotation axis during imaging can be reduced. A deviation of the region of interest from the rotation axis during rotation is for example 150 nanometers (nm) or less (e.g., 100 nm or less, 50 nm or less). A much smaller spatial resolution than one micrometer (μm) can be achieved.

The x-ray imaging system can be configured for imaging a region of interest of a sample. The sample is, for example, a flat extended object. The sample is, for example, a wafer. The wafer includes, for example, electronic and/or semiconductor components. Just as an example, the x-ray imaging system may be used to inspect the wafer to investigate the quality of packaging of electronic components of the wafer. For example, the quality of mechanical and electrical bonding (e.g., buried interconnections) of the electronic components may be controlled. However, the sample may also be another object than a wafer. The sample is, for example, a circuit board or a battery.

The sample may have, for example, a rectangular shape, squared shape and/or circular shape in its main plane of extension. Furthermore, a size of the sample in its main plane of extension may include, for example, a diameter or side length of 100 millimeters (mm) or more (e.g., 200 mm or more, 300 mm or more, 400 mm or more, 500 mm or more).

The x-ray imaging system is, for example, a transmission x-ray imaging system, wherein the x-rays impacting on the region of interest of the sample are partly transmitting the region of interest and are partly absorbed by the region of interest. The position-dependent transmitted portion of the x-rays can be detected by an x-ray detector (e.g., a position-sensitive x-ray detector) as a two-dimensional image.

The x-ray imaging system is, for example, a three-dimensional imaging system. The sample mount assembly is, for example, configured for supporting the sample rotatably around the rotation axis during x-ray imaging. The x-ray imaging system is, for example, configured to obtain two-dimensional transmission images of the region of interest for different rotation angles of the sample. The rotation angles span, for example, a large angular range of 180° or more (e.g., 270° or more, 360°). Based on the two-dimensional transmission images, a three-dimensional image of the region of interest can be reconstructed to reveal interior structures of the region of interest. The x-ray imaging system comprises, for example, a control device for reconstructing the three-dimensional images. The x-ray imaging system is, for example, an x-ray three-dimensional imaging system obtaining three-dimensional images by x-ray laminography and/or x-ray tomography.

The main base of the sample mount assembly is, for example, a fixed base (e.g., a non-moving base).

The linear slide of the sample mount assembly can be attached relative to the rotation stage such that the linear slide can move in the linear direction relative to the rotation stage. The linear slide is, for example, configured for one-dimensional movement in the linear direction relative to the rotation stage. The linear slide can be used for setting a radial coordinate of a specific region of interest of the sample.

The sample mount assembly can comprise the support surface for supporting the sample. The support surface is, for example, a flat surface (e.g., flat on a micrometer and/or nanometer scale). The support surface defines, for example, an object plane of the x-ray imaging system. The support surface is, optionally fixedly, connected with the linear slide such that the support surface maintains its position relative to the slide (i.e. the support surface cannot move relative to the slide). The support surface may be an integral part of the linear slide. For example, the support surface and the linear slide may be implemented as a single or the same part or component (or may be implemented as different parts or components). The support surface is, for example, a surface of a holding unit of the sample mount assembly or a surface of the linear slide. In other words, the holding unit or the linear slide can comprise the support surface.

The support surface has, for example, an opening (e.g., through opening) for accommodating a protruding portion of an x-ray source at least partially and/or for transmission of x-rays towards the sample or from the sample.

The lifting unit can be configured for lifting the sample from the support surface into the lifted state of the lifting unit and the sample. For example, the lifting unit can be configured for lifting the sample from a lowered state of the lifting unit and the sample into the lifted state. The lifting unit is, for example, configured for lifting the sample by a few millimeters (e.g., from 1 mm to 5 mm, from 1 mm to 3 mm) from the support surface.

In the lowered state of the lifting unit and the sample, the sample can be supported by the support surface of the holding unit or the linear slide. In the lowered state, a rotation of the rotation stage can be transmitted to the sample and the sample rotates together with the rotation stage. In the lowered state, a linear movement of the linear slide can be transmitted to the sample and the sample moves linearly together with the linear slide.

In the lifted state of the lifting unit and the sample, the sample can be spaced apart and mechanically decoupled from the support surface. In the lifted state, the sample can be spaced apart from the holding unit and the linear slide. In the lifted state, a rotation of the rotation stage is not transmitted to the sample (note that also a linear movement of the linear slide is not transmitted to the sample). Therefore, in the lifted state, the rotation stage can be rotated without rotating the sample.

The lifting unit is, for example, configured for lifting the sample from the support surface in a direction parallel to the rotation axis. The lifting unit is, for example, configured for exerting a lifting force and/or pressing force to a lower side of the sample for lifting the sample up from the support surface.

The sample mount assembly includes, for example, a rotation drive for rotating the rotation stage, a linear drive for linearly moving the linear slide and/or a lifting drive for lifting a movable portion of the lifting unit.

In some embodiments, the sample mount assembly is configured such that a tilt of the actual rotation axis of the rotation stage relative to an ideal rotation axis of the rotation stage is maintained at an angle of 5 microradians (μrad) or less (e.g., 4 μrad or less, 3 μrad or less). For example, the main base comprises a bearing for supporting the rotation stage rotatably around the rotation axis. The bearing can be a high-precision bearing configured for keeping a tilt of the actual rotation axis of the sample mount relative to an ideal rotation axis at 5 μrad or less (e.g., 4 μrad or less, 3 μrad or less). By keeping a wobble of the rotation axis of the sample mount assembly (e.g., a cyclic tilting of the support surface of the sample mount) relatively small, also the sample supported on the sample mount assembly has a small angular wobble with respect to the rotation axis. Therefore, Abbe errors (sine errors, i.e. a magnification of an angular error over distance) can be kept relatively small.

According to some embodiments, the sample mount assembly is configured for repositioning a sample arranged on the support surface such that a region of interest of the sample is arranged coinciding with the rotation axis.

According to some embodiments, a position of a region of interest of the sample is defined by polar coordinates including a radial coordinate and an angular coordinate. The sample mount assembly can be configured for rotating, in the lifted state of the lifting unit, the rotation stage together with the linear slide and without the sample such that the linear direction of the linear slide coincides with the angular coordinate of the region of interest. The sample mount assembly can be configured for moving, in a lowered state of the lifting unit, the linear slide together with the sample such that the radial coordinate of the region of interest can coincide with the rotation axis of the rotation stage.

In general, the polar coordinates are coordinates of a region of interest of the sample in a main plane of extension of the sample. The polar coordinates include the radial coordinate which is a radial distance from a center of the sample, the center of the sample being a center with respect to the main plane of extension of the sample. The polar coordinates include the angular coordinate which is an azimuthal angle with respect to a reference direction of the sample.

In the lifted state of the lifting unit, the rotation stage can be rotated together with the linear slide but without the sample. This means that the rotation stage and linear slide can be rotated together while the sample remains stationary. In other words, both the rotation stage and the linear slide can be rotated relative to the stationary sample.

According to some embodiments, the sample mount assembly comprises a linear slide unit, wherein the linear slide unit includes: a slide base attached fixedly to the rotation stage; and the linear slide attached to the slide base movably in the linear direction.

One of the slide base and the linear slide comprises, for example, one or more groves. Further, the other one of the slide base and the linear slide comprises, for example, one or more protruding portions (e.g., skids or the like) for being guided in the one or more groves.

According to some embodiments, the lifting unit includes: a lifting base attached fixedly to the main base; and a moveable portion attached moveably to the lifting base.

The movable portion of the lifting unit comprises, for example, a ring-shaped element with an opening. The opening can be configured for accommodating a protruding portion of an x-ray source at least partially and/or for transmission of x-rays. The opening of the movable portion of the lifting unit is, for example, arranged correspondingly to an opening of the rotation stage, an opening of the linear slide unit, an opening of the linear slide, and/or an opening of the holding unit.

The movable portion of the lifting unit further comprises, for example, three or more pins fixedly attached to the ring-shaped element. The three or more pins are, for example, configured for touching a lower side of the sample and exerting a pressing force on the lower side of the sample for lifting the sample. However, the lifting unit, for example the movable portion of the lifting unit, may also have a different configuration.

According to some embodiments, the lifting unit is arranged spaced apart and mechanically decoupled from the rotation stage, the linear slide unit and/or the linear slide.

According to some embodiments, the main base, the rotation stage, the linear slide unit, the linear slide and/or a holding unit each comprises an opening for accommodating a protruding portion of an x-ray source at least partially and/or for passing through of x-rays towards or from the sample.

Having the openings, an unobstructed passing through of x-rays through the sample mount assembly to a region of interest of the sample or from the region of interest of the sample is possible. In other words, a beam path of an x-ray beam emitted from an x-ray source, transmitted through the region of interest of the sample and detected by a detector can be free of material of the sample mount assembly.

The respective opening is, for example, a through opening. The respective opening is, for example, a central opening of the respective component. The openings of the main base, the rotation stage, the linear slide unit, the linear slide and/or the holding unit are arranged, for example, correspondingly to each other. This means that the openings overlap each other such that an x-ray beam can travel unhindered through the openings.

Further, the rotation axis of the sample mount assembly, for example of the rotation stage of the sample mount assembly, can pass through the opening of the main base, the rotation stage, the linear slide unit, the linear slide and/or the holding unit. For example, the rotation axis coincides with a central axis of the opening of the main base, the rotation stage, the linear slide unit, the linear slide and/or the holding unit.

The openings are, for example, at least partially configured for passing through of x-rays emitted by an x-ray source and/or of x-rays transmitted through the region of interest of the sample. In other words, the x-ray imaging system can be configured in a first alternative such that an x-ray beam emitted from the x-ray source passes through the openings of the sample mount assembly before irradiating the region of interest of the sample. In an alternative, the x-ray imaging system is configured such that an x-ray beam emitted from the x-ray source and already transmitted through the region of interest of the sample passes through the openings of the sample mount assembly.

According to some embodiments, the lifting unit is arranged at least partially inside the opening of the rotation stage, the linear slide unit, the linear slide and/or the holding unit.

The lifting unit can exert the lifting and/or pressing force on the sample in a central region of the sample.

According to some embodiments, the sample mount assembly comprises a holding unit attached fixedly to the linear slide for holding a sample, wherein the holding unit or the linear slide comprises the support surface for supporting the sample. Furthermore, the holding unit can be configured for holding the sample by exerting a holding force and/or a suction force on the sample towards the support surface.

Having the holding unit, the sample can be maintained in an even more stable and stationary state during x-ray imaging. For example, even though the rotation stage, linear slide (unit) and the holding unit are rotated together with the sample around the rotation axis during imaging, it can be avoided that the sample moves relative to the sample mount assembly. For example, by holding the sample with the holding unit, vibration of the sample during scanning (i.e. during imaging)—which would deteriorate the image quality—can be reduced and/or avoided. Therefore, by holding (e.g., chucking or clamping) the sample with the holding unit, a precision and/or resolution of the x-ray imaging system can be increased.

Furthermore, the samples analyzed with an x-ray imaging system can be, for example, flat extended objects, such as wafers. However, such a sample may exhibit small deviations from a flat geometry and be, instead, warped and/or curved (e.g., curved away from the support surface of the sample mount assembly; e.g., by a few micrometers or even up to a few millimeters). Such warped and/or curved samples may, for example, arise from the energy input when printing different layers (e.g., 50 to 100 layers) of semiconductor circuits onto a wafer as a sample. A warpage and/or curvature of the sample, even on a small scale, is unfavorably for the x-ray imaging process. With the proposed holding unit, a holding force acts in the direction towards the flat support surface of the sample mount assembly and, therefore, a warped sample can be flattened.

The holding unit has, for example, an opening (e.g., through opening) for accommodating a protruding portion of an x-ray source and/or for transmission of x-rays towards the sample or from the sample. Further, the holding unit has, for example, a ring shape or a horseshoe shape.

The holding unit comprises, for example, at least one suction element (e.g., vacuum chuck) for exerting a suction force on the sample. The at least one suction element comprises, for example, at least one recess recessed from a surface of the holding unit (e.g., the support surface), and at least one suction line fluidly connected to the at least one recess for generating a negative pressure inside the at least one recess. The at least one suction element may comprise multiple spaced apart suction elements arranged along an annulus adjacent an edge of an opening of the holding unit. Just as an example, the multiple suction elements may be evenly distributed along the annulus. However, the at least one suction element may also comprise a ring-shaped suction element or have another configuration.

Alternatively, the holding unit may also comprise, for example, at least one clamping element for exerting a clamping force on the sample.

According to some embodiments, the rotation stage is attached to the main base movably in a plane perpendicular to the rotation axis.

This can allow for adjusting (for example fine-tune) a position of the rotation stage including all components of the sample mount assembly supported by the rotation stage (e.g., the linear slide (unit) and/or the holding unit). Adjusting (e.g., fine-tuning) the position of rotation stage including the components may be desirable when a position of an x-ray detector of the x-ray imaging system has been altered.

For example, an x-ray propagation axis of the x-ray imaging system (which indicates a direction of an x-ray beam from an x-ray source to the region of interest of the sample and to an x-ray detector) may be inclined relative to the object plane by an acute angle. In case that a position of the x-ray detector is (e.g., slightly) changed, a direction of the x-ray propagation axis is changed and, therefore, a relative position of the rotation stage and the x-ray source have to be adapted to the new direction of the x-ray propagation axis. This can be done by moving the rotation stage relative to the main base as proposed in this embodiment.

Furthermore, by moving the rotation stage relative to the main base in the plane perpendicular to the rotation axis, a height of an intersection of the rotation axis with the x-ray propagation axis can be changed. For example, if the rotation stage and, hence, the rotation axis are moved in the plane perpendicular to the rotation axis such that the rotation axis is moved further away from the x-ray source, the x-ray propagation axis will penetrate the sample at a larger height. Thus, a region of interest of the sample at a larger height can be imaged. The term “height” used herein is a height with respect to a direction parallel to the rotation axis and/or a direction pointing away from the support surface of the sample mount assembly and being parallel to a surface normal of the support surface.

Alternatively, a relative position of the rotation stage of the sample mount assembly and the x-ray source can be adapted by keeping the rotation stage fixed and moving the x-ray source.

According to an aspect, the disclosure provides an x-ray imaging system for imaging a sample. The x-ray imaging system comprises an above-described sample mount assembly.

The x-ray imaging system can further comprise an x-ray source for emitting x-rays towards a region of interest of the sample and an x-ray detector for detecting x-rays transmitted through the region of interest.

The x-ray source comprises, for example, a vacuum chamber. Further, the x-ray source comprises, for example, a pump for evacuating the vacuum chamber. The x-ray source further comprises, for example, an electron source accommodated in the vacuum chamber. The electron source can be configured for emitting an electron beam towards an x-ray target of the x-ray source. The electron source includes, for example, a cathode and an anode and the like for generating electrons and for accelerating the generated electrons.

The x-ray source comprises, for example, one or more electron optics units for directing, deflecting and/or shaping the electron beam emitted from the electron source. The electron optics include, for example, one or more magnetic lenses for focusing the electron beam and/or one or more deflection units for deflecting the electron beam.

The x-ray source further comprises, for example, an x-ray target. The x-ray target can be configured for emitting x-rays when bombarded with the focused electron beam. A material of the at least one x-ray target comprises, for example, one or more of a group including tungsten (W), copper (Cu), chromium (Cr), molybdenum (Mo), rhodium (Rh) and platinum (Pt). The x-rays generated by the at least one x-ray target include, for example, characteristic lines determined by the target's composition and broad bremsstrahlung radiation.

The x-ray source includes, for example, a carrier element carrying the x-ray target (or carrying multiple of the x-ray targets which can be selected by directing the electron beam accordingly). The carrier element is, for example, x-ray transmissive. The carrier element forms, for example, a vacuum window of the vacuum chamber. Alternatively, an additional vacuum window may be provided. A material of the carrier element and/or the vacuum window includes, for example, atomic elements having atomic numbers less than 14. The material of the carrier element and/or the vacuum window includes, for example, one or more of a group including beryllium (Be), diamond, boron carbide (B₄C), silicon carbide (SiC), aluminum (Al), and beryllium oxide (BeO). The material of the carrier element and/or the vacuum window can be diamond.

The carrier element and/or the vacuum window being x-ray transmissive means, for example, that it has an x-ray transmission such that more than 50% of the x-rays generated by the at least one x-ray target having energies greater than one-half of the selected maximum focused electron energy are transmitted through the carrier element.

The carrier element has, for example, a sufficiently high thermal conductivity to provide a thermal conduit to prevent thermal damage (e.g., melting) of the x-ray target. Further, the carrier element can, for example, also provide an electrically conductive path to dissipate electric charge from the at least one x-ray target and/or the carrier element itself.

The x-ray source is, for example, a transmission target type x-ray source. The electron beam can strike the at least one x-ray target of the x-ray source at its backside, the at least one x-ray target can emit x-rays at its front side, and the emitted x-rays can be used to irradiate the sample.

The x-ray source can generate diverging x-rays, i.e., a cone (conus) of x-rays. A portion (i.e. a sub cone) of the generated diverging x-rays can irradiate the region of interest of the sample. A center line of this sub cone of x-rays is referred to as x-ray propagation axis. This means that the x-ray propagation axis indicates the direction of an x-ray beam which is a portion of the total generated diverging x-rays of the x-ray source.

The x-ray detector is, for example, a position-sensitive x-ray detector. The x-ray detector is, for example, configured for converting incoming x-rays into light of longer wavelength, e.g., ultraviolet light, visible light or infrared light. The x-ray detector includes, for example, a scintillator material at an entrance window of the detector for converting the x-rays into detectable light and a detector array (e.g., a CCD or CMOS array) for detecting the detectable light.

According to some embodiments, the x-ray imaging system further comprises an x-ray source for emitting x-rays towards a region of interest of the sample, wherein the x-ray source comprises a protruding portion protruding from a remaining portion of the x-ray source, the protruding portion includes an x-ray target, and the protruding portion of the x-ray source is configured for at least partial insertion into an opening of the main base, an opening of the rotation stage, an opening of a linear slide unit, an opening of the linear slide and/or an opening of a holding unit.

Having the protruding portion with the x-ray target protruding from the remaining portion of the x-ray source and inserting it at least partially into the openings of the sample mount assembly can allow for arranging the x-ray target of the x-ray source very close to the region of interest of the sample. Since the x-ray flux incident on the region of interest is generally inversely proportional to the square of the distance of the region of interest from the x-ray target, with the proposed configuration a relatively high x-ray flux density at the region of interest of the sample is achieved. A relatively high x-ray flux density at the region of interest can imply relatively short exposures times and, therefore, a series of samples can be analyzed relatively quickly with the x-ray imaging system resulting in a high throughput rate.

That the protruding portion of the x-ray source is configured for at least partial insertion into the openings of the sample mount assembly can include that a cross section of the protruding portion is smaller than a cross section of the openings.

According to some embodiments, the x-ray imaging system is configured for obtaining two-dimensional transmission images of a region of interest of the sample for different rotation angles of the sample with respect to the rotation axis, and for reconstructing a three-dimensional image of the region of interest based on the two-dimensional transmission images.

According to an aspect, the disclosure provides a method for operating an above-described sample mount assembly. The method comprises: a) arranging a sample on a support surface of the sample mount assembly, the sample comprising a region of interest with a position being defined by polar coordinates including a radial coordinate and an angular coordinate; b) lifting the sample from the support surface into a lifted state; c) rotating the rotation stage together with a linear slide and without the sample around the rotation axis such that a linear direction of the linear slide coincides with the angular coordinate of the region of interest; d) lowering the sample from the lifted state to a lowered state in which the sample is supported by the support surface; and e) moving the linear slide together with the sample relative to the rotation stage in the linear direction perpendicular to the rotation axis such that the radial coordinate of the region of interest coincides with the rotation axis.

The method may include, after d), exerting a holding force (e.g., starting to exert a holding force) on the sample by a holding unit.

According to an aspect, the disclosure provides a method for operating an x-ray imaging system. The x-ray imaging system comprises an above-described sample mount assembly. The method comprises: including the above-described steps a) to e) of the method according; rotating the sample around the rotation axis into different rotation angles by rotating the rotation stage together with the linear slide; emitting x-rays towards the region of interest of the sample; and detecting x-rays transmitted through the region of interest for the different rotation angles of the sample.

The embodiments and features described with reference to the first aspect of the present disclosure apply mutatis mutandis to the second to fourth aspects of the present disclosure and vice versa.

Further possible implementations or alternative solutions of the disclosure also encompass combinations - that are not explicitly mentioned herein - of features described above or below with regard to the embodiments. The person skilled in the art may also add individual or isolated aspects and features to the most basic form of the disclosure.

### BRIEF DESCRIPTION OF THE DRAWINGS

Further embodiments, features and aspects of the present disclosure will become apparent from the subsequent description and dependent claims, taken in conjunction with the accompanying drawings, in which:

FIG. 1 shows a schematic cross-section view of an x-ray imaging system for imaging a sample;

FIG. 2 shows a schematic cross-section view of an x-ray imaging system with a sample mount assembly;

FIG. 3 shows a perspective explosion view of the sample mount assembly of FIG. 2;

FIG. 4 shows a perspective view of the sample mount assembly of FIG. 2 in an assembled state;

FIG. 5 shows a flow chart illustrating a method for operating a sample mount assemble;

FIG. 6 shows a top view of a sample;

FIG. 7 shows the sample mount assembly of FIG. 2 in a top view (upper panel) and in a cross-section view similar as in FIG. 2 (lower panel) in a lifted state of a lifting unit and a sample;

FIG. 8 shows a view similar as FIG. 7 but with a rotating stage of the sample mount assembly being rotated;

FIG. 9 shows a view similar as FIG. 8 but with the lifting unit and the sample being in the lowered state;

FIG. 10 shows a view similar as FIG. 9 but with a linear slide of the sample mount assembly being moved linearly and the rotating stage being rotated; and

FIG. 11 shows a flow chart illustrating a method for operating an x-ray imaging system.

### DETAILED DESCRIPTION

In the Figures, like reference numerals designate like or functionally equivalent elements, unless otherwise indicated.

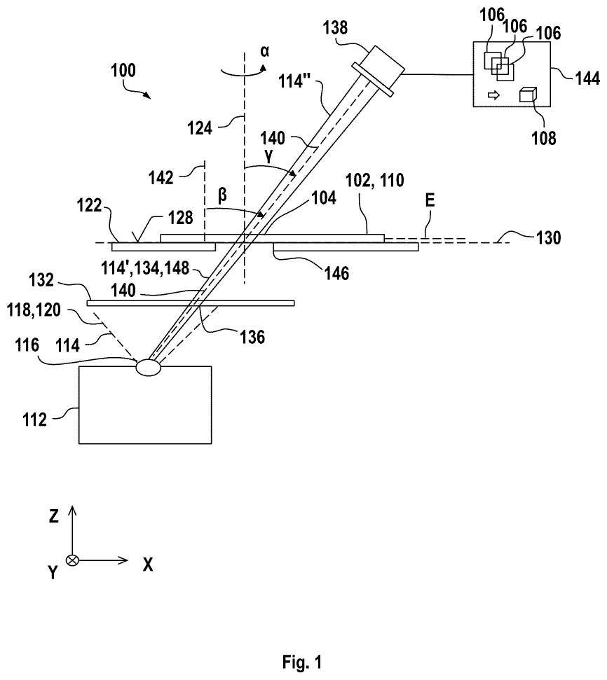

FIG. 1 shows a schematic view of an x-ray imaging system 100 according to an embodiment. The x-ray imaging system 100 is used for imaging a sample 102, for example a region of interest 104 of the sample 102. The x-ray imaging system 100 is configured to obtain two-dimensional transmission images 106 of the region of interest 104 for different rotation angles α of the sample 102. Based on the two-dimensional transmission images 106, a three-dimensional (3D) image 108 of the region of interest 104 is reconstructed to reveal interior structures of the region of interest 104. The x-ray imaging system 100 is, hence, an x-ray 3D imaging system obtaining 3D images 108 by x-ray laminography and/or x-ray tomography. The sample 102 is, for example, a flat object extended in a main plane E (e.g., the xy-plane in FIG. 1). The sample 102 is, for example, a wafer 110 comprising electronic and/or semiconductor components. Just as an example, the x-ray imaging system 100 may be used to inspect the wafer 110 to investigate the quality of packaging of electronic components of the wafer 110. For example, the quality of mechanical and electrical bonding (e.g., buried interconnections) of the electronic components may be controlled.

The x-ray imaging system 100 comprises an x-ray source 112 for emitting x-rays 114. The x-rays 114 are emitted from a source region 116 of the x-ray source 112. The x-ray source 112 emits a diverging beam 118 of x-rays 114. In other words, the x-ray source 112 emits a cone 120 of x-rays 114. The sample 102 is arranged within the x-ray emission cone 120.

The x-ray imaging system 100 further comprises a sample mount assembly 122 for supporting the sample 102 rotatably around a rotation axis 124. The rotation axis 124 passes, for example, through the region of interest 104 of the sample 102. For example, the rotation axis 124 can be arranged off-center with respect to a center of the sample 102. Furthermore, the sample mount assembly 122 has a support surface 128 for supporting the sample 102, wherein the support surface 128 defines an object plane 130 of the x-ray imaging system 100.

The x-ray imaging system 100 may optionally comprise, for example, a shield stop 132 arranged between the x-ray source 112 and the sample mount assembly 122. The shield stop 132 is, for example, arranged in a light path of the x-rays 114 emitted from the x-ray source 112. The shield stop 132 serves to select a usable portion 134 (sub cone 134) of the x-ray cone 120. Moreover, the shield stop 132 protects uninspected regions of the sample 102 from x-ray exposure. The shield stop 132 has an aperture 136 through which the usable portion 134 of the x-ray light 114 (114′) propagates in the direction of the region of interest 104 of the sample 102 and transmits the region of interest 104 of the sample 102.

The x-ray imaging system 100 further comprises a position-sensitive x-ray detector 138 for detecting x-rays 114″ transmitted through the region of interest 104 of the sample 102. The position-sensitive x-ray detector 138 is, for example, configured to convert the incoming x-rays 114″ into light of longer wavelength, e.g., ultraviolet light, visible light or infrared light. The x-ray detector 138 includes, for example, a scintillator material at an entrance window of the detector 138 for converting the incoming x-rays 114″ into detectable light and a detector array (e.g., a CCD or CMOS array) for detecting the detectable light.

FIG. 1 displays an x-ray propagation axis 140 of the x-ray imaging system 100. For example, a central axis of the portion 134 (sub light cone 134) of the x-ray light 114 passing through the shield stop 132 defines the x-ray propagation axis 140. The x-ray propagation axis 140 extends from the x-ray source 112 (i.e., the source region 116 of the x-ray source 112), through the region of interest 104 of the sample 102, and to the position-sensitive x-ray detector 138.

As can be seen in FIG. 1, the x-ray propagation axis 140 of the x-ray imaging system 100 is, for example, inclined with respect to a surface normal 142 of the object plane 130 by a first angle β. In addition, the x-ray propagation axis 140 is, for example, inclined with respect to the rotation axis 124 by a second angle γ. In the example of FIG. 1, the surface normal 142 of the object plane 130 and the rotation axis 124 are arranged parallel to each other and, hence, the first angle β and the second angle γ have the same size.

The x-ray exposures 106 obtained at different rotation angles α of the sample 102 are reconstructed to a 3D image 108 by a control system 144 of the imaging system 100.

The x-ray imaging system 100 provides microscopic imaging. A magnification and, hence, a spatial resolution, of the x-ray imaging system 100 depends on the geometric magnification of the system 100. The geometric magnification of the system 100 is given by a ratio of a distance between the x-ray source 112 and the x-ray detector assembly 138 and a distance between the x-ray source 112 and the region of interest 104 of the sample 102.

Moreover, an imaging time used to obtain a 3D image 108 of the region of interest 104 of the sample 102 depends on the x-ray flux density at the region of interest 104. The imaging time (exposure time) limits, for example, a throughput rate when imaging multiple samples 102 with the x-ray imaging system 100. The smaller the distance between the x-ray source 112 and the region of interest 104 of the sample 102, the higher is the x-ray flux density at the region of interest 104 of the sample 102. For example, the x-ray flux incident on the region of interest 104 is inversely proportional to the square of the distance of the region of interest 104 from the x-ray source 112 (for example, from an x-ray target of the x-ray source 112).

As shown in FIG. 1, the sample mount assembly 122 has an opening 146 for passing through of the x-rays 114′emitted from the x-ray source 112 to the sample 102. With the opening 146 of the sample mount assembly 122, it can be prevented that the x-ray beam 134 traveling from the x-ray source 112 to the region of interest 104 of the sample 102 and further to the x-ray detector 138 transmits a material of the sample mount assembly 122. In other words, a beam path 148 of the x-ray beam 134 emitted from the x-ray source 112, transmitted through the region of interest 104 and detected by the detector 138 is free of (i.e. unobstructed by) material of the sample mount assembly 122. Hence, an attenuation of the x-ray beam 134 by material of the sample mount assembly 122 can be avoided. The opening 146 may also be configured for accommodating a protruding portion of an x-ray source at least partially.

In the examples shown in the figures, the respective x-ray imaging system (e.g., x-ray imaging system 100) is configured such that the x-ray beam 134 emitted from the x-ray source 112 passes through the opening 146 of the sample mount assembly 122 before irradiating the region of interest 104 of the sample 102. However, although not shown in the figures, an x-ray imaging system may also be configured such that - in the orientation of FIG. 1—an x-ray source 112 is arranged above the sample 102 and the sample mount assembly 122 (e.g., in an adapted configuration), and an x-ray detector 138 is arranged below the sample 102 and the sample mount assembly 122. In this case, the opening 146 of the sample mount assembly 122 would be configured for passing through of the x-rays 114″ transmitted through the region of interest 104 and traveling to the detector 138. In other words, in this case, an x-ray beam already transmitted through the region of interest 104 of the sample 102 passes through the opening 146 of the sample mount assembly 122 before reaching the detector 138.

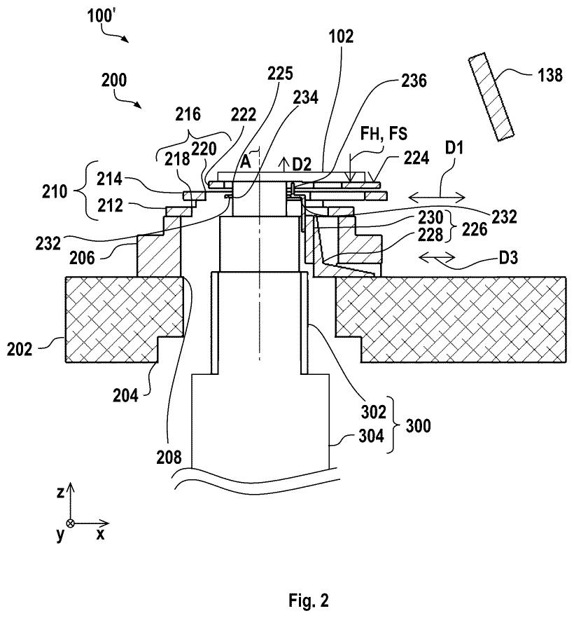

FIG. 2 shows an x-ray imaging system 100′with a detailed view of a sample mount assembly 200 according to a further embodiment. If not otherwise described, the features described with reference to FIG. 1 apply also to FIG. 2.

The sample mount assembly 200 comprises a main base 202 with a central opening 204 (first opening 204). The sample mount assembly 200 further comprises a rotation stage 206 attached rotatably to the main base 202. For example, the rotation stage 206 is rotatable around a rotation axis A with respect to the main base 202. The rotation axis A is arranged parallel to the z-direction in FIG. 2. The sample mount assembly 200 comprises a rotation drive (not shown) to drive a rotation of the rotation stage 206. The rotation stage 206 has a central opening 208 (second opening 208) corresponding to the first opening 204 of the main base 202.

The sample mount assembly 200 further comprises a linear slide unit 210 attached to the rotation stage 206. The linear slide unit 210 includes a slide base 212 and a linear slide 214. The slide base 212 is fixedly attached to the rotation stage 206. Furthermore, the linear slide 214 is attached movably to the slide base 212. For example the linear slide 214 is attached to the slide base 212 such that the linear slide 214 can move in a linear direction D1 relative to the slide base 212. The linear direction D1 is arranged parallel to the x-direction in FIG. 2. The linear direction D1 is arranged perpendicular to the rotation axis A of the rotation stage 206.

The linear slide unit 210 comprises an opening 216 (third opening 216) corresponding to the first and second openings 204, 208. For example, each of the slide base 212 and the linear slide 214 comprises an opening 218, 220 arranged correspondingly to each other and to the other openings 204, 208.

The sample mount assembly 200 comprises in addition optionally a holding unit 222 for holding the sample 102. The holding unit 222 comprises, for example, a support surface 224 (similar as the support surface 128 in FIG. 1) for supporting the sample 102. The holding unit 222 is fixedly attached to the linear slide 214 of the linear slide unit 210. The holding unit 222 also comprises a central opening 225 (fifth opening 225) arranged correspondingly to the other openings 204, 208, 216.

In the shown figures and related description, the support surface 224 is shown and described as a surface of the holding unit 222. However, in other examples, the support surface 224 may also be a surface of the linear slide 214. In this case, the holding unit 222 may be configured, for example, as one or more clamps for clamping the sample 102 to the support surface 224 of the linear slide 214.

The holding unit 222 is, for example, configured for holding the sample 102 by exerting a holding force F_{H} on the sample 102 in the direction of the support surface 224. The holding unit 222 comprises, for example, one or more suction elements such as vacuum chucks (not shown) for exerting a suction force F_{S} on a lower surface of the sample 102 (the lower surface of the sample 102 in the orientation of FIG. 2).

As shown in FIG. 2, the sample mount assembly 200 also comprises a lifting unit 226. The lifting unit 226 is configured for lifting the sample 102 from the support surface 224 in a direction D2 parallel to the rotation axis A. The lifting unit 226 comprises a lifting base 228 fixedly attached to the main base 202. The lifting unit 226 further comprises a movable portion 230 movably attached to the lifting base 228. In the example of FIG. 2, the movable portion 230 comprises a ring element 232 with an opening 234. The movable portion 230 also comprises three or more pins 236 fixedly attached to the ring element 232. The pins 236 are configured for contacting the lower surface of the sample 102 for pressing on the sample 102 in the direction D2 for lifting the sample 102.

The lifting unit 226 is arranged spaced apart and mechanically decoupled from the rotation stage 206 and the linear slide unit 210. The lifting unit 226 is, for example, arranged at least partially inside the opening 208 of the rotation stage 206, the opening 216 of the linear slide unit 210 and the opening 225 of the holding unit 222.

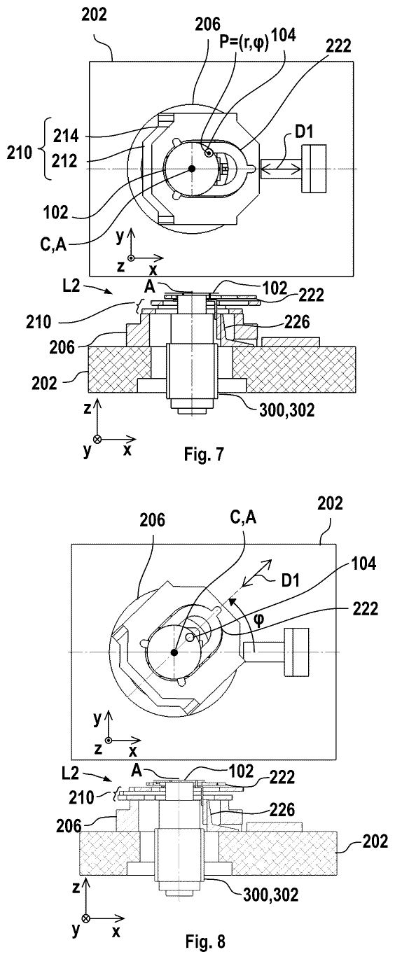

The lifting unit 226 is configured for lifting the sample 102 from a lowered state L1 of the lifting unit 226 and the sample 102 (FIGS. 2, 9, 10) into a lifted state L2 of the lifting unit 226 and the sample 102 (FIGS. 7, 8).

In the lowered state L1 of the lifting unit 226 and the sample 102 (FIGS. 2, 9, 10), the sample 102 is supported by the support surface 224. Hence, in the lowered state L1, a rotation of the rotation stage 206 is transmitted (via the slide unit 210 or via the slide unit 21 and the holding unit 222) to the sample 102 and the sample 102 rotates together with the rotation stage 206. Further, in the lowered state L1, a linear movement of the linear slide 220 is transmitted to the sample 102 and the sample 102 moves linearly together with the linear slide 220.

In the lifted state L2 of the lifting unit 226 and the sample 102 (FIGS. 7, 8), the sample 102 is spaced apart from the support surface 224 and mechanically decoupled from the linear slide 220 (or mechanically decoupled from the linear slide 220 and the holding unit 222). Hence, in the lifted state L2, a rotation of the rotation stage 206 is not transmitted to the sample 102. Therefore, in the lifted state L2, the rotation stage 206 can be rotated without rotating the sample 102.

The openings 204, 208, 216, 225, 234 of the sample mount assembly 200 are configured for accommodating a protruding portion 302 of an x-ray source 300 at least partially and/or for passing through of x-rays 114′ (similar as the opening 146 shown in FIG. 1).

As shown in FIG. 2, an x-ray source 300 of the x-ray imaging system 100′may optionally comprise a protruding portion 302 protruding from a remaining portion 304 of the x-ray source 300. The protruding portion 302 includes an x-ray target (not shown). Furthermore, the protruding portion 302 of the x-ray source 300 is configured for at least partial insertion into the opening 204 of the main base 202, the opening 208 of the rotation stage 206, the opening 216 of the linear slide unit 210, the opening 225 of the holding unit 222, and/or the opening 234 of the lifting unit 226. With this configuration, a distance between the x-ray source 300, for example the x-ray target of the x-ray source 300, and the region of interest 104 of the sample 102 can be made very small leading to a high x-ray flux density at the region of interest 104.

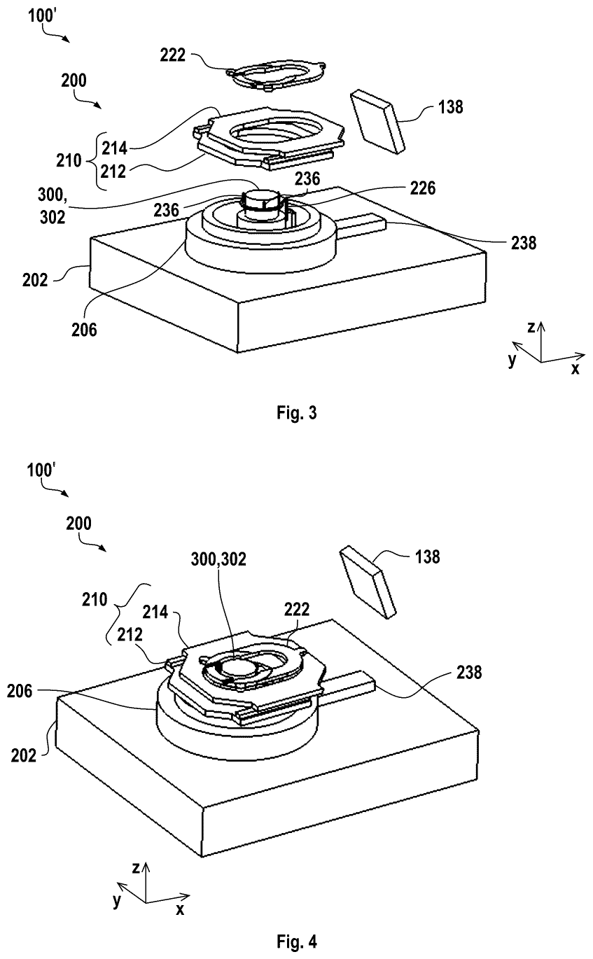

Optionally, the rotation stage 206 is attached movably to the main base 202. For example, the rotation stage 206 is attached movably to the main base 202 such that the rotation stage 206 can be moved relative to the main base 202 in a plane (xy-plane in FIG. 2) perpendicular to the rotation axis A. This is illustrated in the cross-section view of FIG. 2 by the arrow D3. Further, in FIGS. 3, 4 a linear stage actuator 238 for moving the rotation stage 206 in the x-direction is shown. Note that a second linear stage actuator for moving the rotation stage 206 in the y-direction may be provided but is not shown in the figures.

Having the rotation stage 206 attached movably in the xy-plane to the main base 202 allows adjusting a position of the rotation stage 206 (including all components 210, 222 of the sample mount assembly 200 supported by rotation stage 206) in case that the position of the x-ray detector 138, and hence, an orientation of the x-ray propagation axis 140 (FIG. 1) has been altered. Alternatively, a relative position of the rotation stage 206 of the sample mount assembly 200 and the x-ray source 300 can be adapted by keeping the rotation stage 206 fixed and moving the x-ray source 300.

FIG. 3 shows a perspective explosion view of the sample mount assembly 200 of FIG. 2. Further, FIG. 4 shows a perspective view of the sample mount assembly 200 in an assembled state.

The sample mount assembly 200 is, for example, configured for repositioning a sample 102 arranged on the support surface 224 of the sample mount assembly 200 such that a region of interest 104 of the sample 102 is arranged coinciding with the rotation axis A.

FIG. 6 shows a top view of a sample 102. The sample 102 comprises a region of interest 104 with a position P being defined by polar coordinates r, φ including a radial coordinate r and an angular coordinate φ. The radial coordinate r gives a distance of the position P of the region of interest 104 from a center C of the sample 102. The angular coordinate φ gives an azimuthal angle between the radius r pointing to the position P of the region of interest 104 and a reference direction B.

FIGS. 7 to 10 each show in the upper panel a top view of the sample mount assembly 200 and the sample 102 and in the bottom view a cross-section view similar as in FIG. 2.

The sample mount assembly 200 is configured for rotating, in the lifted state L2 of the lifting unit 226 (FIGS. 7, 8), the rotation stage 206 together with the linear slide 214 and without the sample 102 such that the linear direction D1 of the linear slide 214 coincides with the angular coordinate φ of the position P of the region of interest 104. Moreover, the sample mount assembly 200 is configured for moving, in a lowered state L1 of the lifting unit 226 (FIGS. 2, 9, 10), the linear slide 214 together with the sample 102 such that the radial coordinate r of the position P of the region of interest 104 coincides with the rotation axis A of the rotation stage 206.

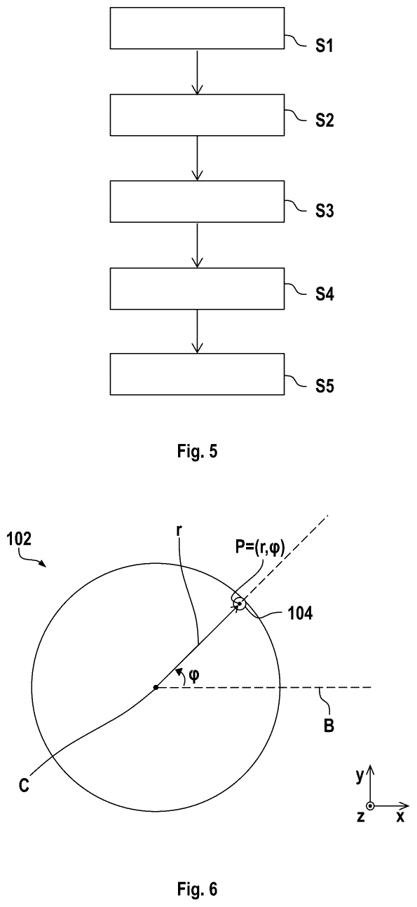

In the following, a method for operating a sample mount assembly 200 is described with reference to FIG. 5.

In a first step S1 of the method, a sample 102 is arranged on a support surface 224 of the sample mount assembly 200, as shown in FIG. 2.

In a second step S2 of the method, the sample 102 is lifted from the support surface 224 into a lifted state L2, as shown in FIG. 7. In the lower panel of FIG. 7, a very small gap (e.g., a few Millimeter, e.g., between 1 mm and 3 mm) between the support surface 224 of the holding unit 222 and the sample 102 is visible.

In a third step S3 of the method, the rotation stage 206 is rotated together with the linear slide 214 and without the sample 102 around the rotation axis A such that the linear direction D1 of the linear slide 214 coincides with the angular coordinate φ of the region of interest 104.

The result of this rotation is illustrated in FIG. 8. That means while the sample 102 remained stationary between FIGS. 7 and 8, the rotation stage 206 together with the linear side unit 210 and the holding unit 222 were rotated around the rotation axis A from a first angular position in FIG. 7 to a second angular position in FIG. 8. For example, the rotation stage 206 together with the linear side unit 210 and the holding unit 222 were rotated such that the linear direction D1 of the linear slide 214 was rotated to the azimuthal angle φ of the position P of the region of interest 104 of the sample (see also FIG. 6).

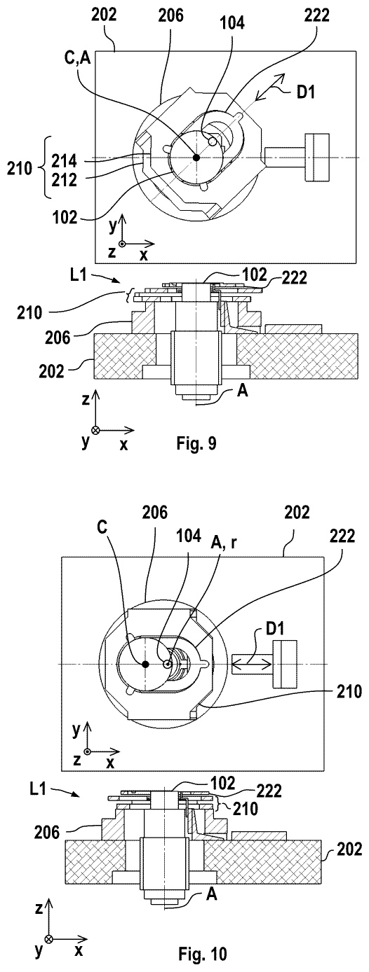

In a fourth step S4 of the method, the sample 102 is lowered from the lifted state L2 to a lowered state L1 in which the sample 102 is supported by the support surface 224. This is illustrated in FIG. 9. For example, the only difference between FIGS. 8 and 9 is that in FIG. 8 the lifting unit 226 and the sample 102 are in the lifted state L2 and in FIG. 9, the lifting unit 226 and the sample 102 are in the lowered state L1.

In a fifth step S5 of the method, the linear slide 214 together with the sample 102 is moved relative to the rotation stage 206 in the linear direction D1 perpendicular to the rotation axis A such that also the radial coordinate r of the region of interest 104 coincides with the rotation axis A of the rotation stage 206.

In FIG. 10, the result of the movement of the linear slide 214 together with the sample 102—such that the radial coordinate r of the region of interest 104 and, hence, the overall position P =(r, φ) of the region of interest 104 coincides with the rotation axis A—is shown. In FIG. 10, in addition to step S5, the rotation stage 206 has also been rotated into a measurement starting position for x-ray imaging of the region of interest 104.

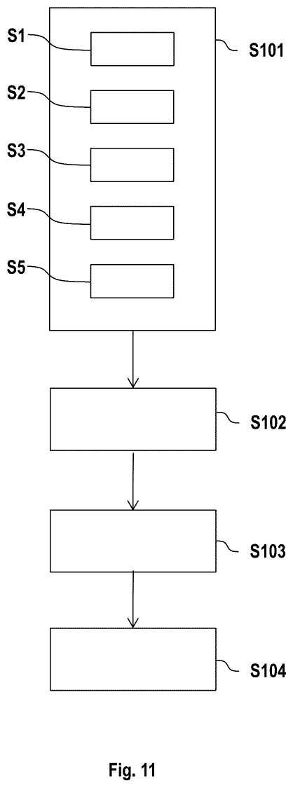

In the following, a method for operating an x-ray imaging system 100, 100′is described with reference to FIG. 11.

In a first step 101 of the method according to FIG. 11, the steps S1 to S5 of the method according to FIG. 5 are carried out.

In a second step 102 of the method according to FIG. 11, the sample 102 is rotated around the rotation axis A intersecting the region of interest 104 into different rotation angles α (FIG. 1) by rotating the rotation stage 206 together with the linear slide 214 (and the holding unit 222).

In a third step 103 of the method according to FIG. 11, x-rays 114, 114′ (FIG. 1) are emitted towards the region of interest 104 of the sample 102.

In a fourth step 104 of the method according to FIG. 11, x-rays 114″ (FIG. 1) transmitted through the region of interest 104 for the different rotation angles α of the sample 102 are detected.

Although the present disclosure has been described in accordance with certain embodiments, it is obvious for the person skilled in the art that modifications are possible in all embodiments.

### REFERENCE NUMERALS

100, 100′System
102 Sample
104 Region of interest
106 2D image
108 3D image
110 Wafer
112 Source
114 X-ray
114′, 114″ X-ray
116 Source region
118 Beam
120 Cone
122 Sample mount assembly
124 Rotation axis
128 Surface
130 Object plane
132 Shield stop
134 Sub cone
136 Aperture
138 Detector
140 Axis
142 Surface normal
144 Control system
146 Opening
200 Sample mount assembly
202 Main base
204 Opening
206 Rotation stage
208 Opening
210 Slide unit
212 Slide base
214 Slide
216 Opening
218 Opening
220 Opening
222 Holding unit
224 Surface
225 Opening
226 Lifting unit
228 Lifting base
230 Movable portion
232 Ring element
234 Opening
236 Pin
238 Actuator
300 Source
302 Portion
304 Portion
α Angle
β Angle
γ Angle
φ Coordinate (angle)
A Rotation axis
B Direction
C Center
D1-D3 Direction
E Plane
F_{H} Force
F_{S} Force
L1, L2 State
P Position
r Coordinate
S1-S5 Method steps
S101-S104 Method steps
x,y,z Direction

What is claimed is:

1. A sample mount assembly, comprising:
a main base;
a rotation stage that is rotatable about a rotation axis, the rotation stage being connected to the main base;
a linear slide movable in a linear direction, the linear slide being connected to the rotation stage; and
a support surface connected to or formed integrally with the linear slide, the support surface being configured to support a sample.

2. The sample mount assembly of claim 1, wherein the support surface is connected to the linear slide to support the sample.

3. The sample mount assembly of claim 1, wherein the support surface is formed integrally with the linear slide to support the sample.

4. The sample mount assembly of claim 1, further comprising a lifting unit configured to lift the sample from the support surface so that in a lifted state of the lifting unit:
i) the rotation stage is rotatable without rotating the sample; and
ii) the sample mount assembly is configured to reposition the sample on the support surface so that a region of interest of the sample coincides with the rotation axis.

5. The sample mount assembly of claim 4, wherein:
a position of a region of interest of the sample is defined by polar coordinates which comprise a radial coordinate and an angular coordinate; and
the sample mount assembly is configured to:
i) in the lifted state of the lifting unit, rotate the rotation and linear stages without rotating the sample so that the linear direction of the linear slide coincides with the angular coordinate of the region of interest; and
ii) in a lowered state of the lifting unit, move the linear slide together with the sample so that the radial coordinate of the region of interest coincides with the rotation axis of the rotation stage.

6. The sample mount assembly of claim 1, further comprising a linear slide unit which comprises:
a slide base fixedly connected to the rotation stage; and
the linear slide,
wherein the linear slide is attached to the slide base.

7. The sample mount assembly of claim 1, wherein the lifting unit (226) includes a lifting base (228) attached fixedly to the main base (202), and a moveable portion (230) attached moveably to the lifting base (228).

8. The sample mount assembly of claim 1, wherein the lifting unit is spaced apart from and mechanically decoupled from at least one member selected from the group consisting of the rotation stage, the linear slide unit, and the linear slide.

9. The sample mount assembly of claim 1, wherein each of the main base, the rotation stage, the linear slide unit and the linear slide comprises an opening configured to: i) at least partially accommodate a protruding portion of an x-ray source; and/or ii) have x-rays coming from or going to the sample pass therethrough.

10. The sample mount assembly of claim 9, wherein the lifting unit is at least partially inside the opening of at least one member selected from the group consisting of the rotation stage, the linear slide unit, and the linear slide.

11. The sample mount assembly of claim 1, further comprising a holding unit configured to hold the sample, wherein each of the main base, the rotation stage, the linear slide unit, the linear slide and the holding unit comprises an opening configured to: i) at least partially accommodate a protruding portion of an x-ray source; and/or ii) have x-rays coming from or going to the sample pass therethrough.

12. The sample mount assembly of claim 11, wherein the lifting unit is at least partially inside the opening of at least one member selected from the group consisting of the rotation stage, the linear slide unit, the linear slide, and the holding unit.

13. The sample mount assembly of claim 1, further comprising a holding unit fixedly connected to the linear slide to hold the sample, wherein the holding unit:
i) the holding unit or the linear slide comprises the support surface; and
ii) the holding unit is configured to hold the sample by exerting a holding force and/or a suction force on the sample in a direction toward the support surface.

14. The sample mount assembly of claim 1, wherein the rotation stage is movably connected to the main base in a plane perpendicular to the rotation axis.

15. An x-ray imaging system, comprising:
a sample mount assembly according to claim 1,
wherein the x-ray imaging system is configured to image the sample.

16. The x-ray imaging system of claim 15, further comprising an x-ray source configured to emit x-rays toward a region of interest of the sample,
wherein:
the x-ray source comprises a first portion and a second portion different from the first portion;
the first portion protrudes from the second portion;
the first portion comprises an x-ray target;
the first portion is configured to be at least partially inserted into an opening in at least one member selected from the group consisting of the main base, the rotation stage, a linear slide unit, and the linear slide.

17. The x-ray imaging system of claim 16, wherein the x-ray imaging system is configured to:
i) obtain two-dimensional transmission images of a region of interest of the sample for different rotation angles of the sample with respect to the rotation axis; and
ii) reconstruct a three-dimensional image of the region of interest based on the two-dimensional transmission images.

18. The x-ray imaging system of claim 15, wherein the x-ray imaging system is configured to:
i) obtain two-dimensional transmission images of a region of interest of the sample for different rotation angles of the sample with respect to the rotation axis; and
ii) reconstruct a three-dimensional image of the region of interest based on the two-dimensional transmission images.

19. A method, comprising:
providing a sample mount assembly according to claim 1;
arranging a sample on the support surface of the sample mount assembly, the sample comprising a region of interest with a position defined by polar coordinates which comprise a radial coordinate and an angular coordinate;
lifting the sample from the support surface into a lifted state;
rotating the rotation stage and the linear slide around the rotation axis without rotating the sample, so that a linear direction of the linear slide coincides with the angular coordinate of the region of interest;
lowering the sample from the lifted state to a lowered state in which the sample is supported by the support surface; and
moving the linear slide and the sample relative to the rotation stage in the linear direction perpendicular to the rotation axis so that the radial coordinate of the region of interest coincides with the rotation axis.

20. The method of claim 19, further comprising:
rotating the sample around the rotation axis into different rotation angles by rotating the rotation stage together with the linear slide;
emitting x-rays toward the region of interest of the sample; and
detecting x-rays transmitted through the region of interest for the different rotation angles of the sample.
